(19) United States
(12) Patent Application Publication
(10) Pub. No.: US 2004/0009278 A1
(43) Pub. Date: Jan. 15, 2004

(54) Sourdough pancake and waffle batter and method for making sourdough pancakes and waffles

(76) Inventor: Leo Shiets, Fort Myers, FL (US)

Correspondence Address: PURDUE LAW OFFICES, 2735 N. HOLLAND-SYLVANIA ROAD, SUITE B-2, TOLDEO, OH, 43615

(21) Appl. No.: 10/608,177

(22) Filed: Jun. 26, 2003

Related U.S. Application Data
(60) Provisional application No. 60/391,820, filed on Jun. 26, 2002.

(51) Int. Cl. A21D 10/04

(52) U.S. Cl. 426/552

(57) ABSTRACT

A method for making sourdough pancakes and waffles is disclosed. The method comprises the steps of making a sourdough pre-mix from sourdough sponge that has been proofed, cooling and storing the sourdough pre-mix, removing a portion of the sourdough pre-mix, adding a leavening agent to the pre-mix to produce a batter and preparing sourdough pancakes or waffles from the batter. Preferably, the proofed sourdough sponge is reproofed before the pre-mix is made. Remarkably delicious and pungent sourdough pancakes and waffles are produced.

### BACKGROUND OF THE INVENTION

1. Field of the Invention

This invention pertains to sourdough pancakes and waffles, to a method for preparing them and to a virtually complete sourdough pancake and waffle batter that can be refrigerated and/or frozen for future use.

2. Description of the Prior Art

Sourdough pancakes are truly a delight but, at the same time, truly complicated in the making. A typical prior art method for making sourdough pancakes begins with what is called a starter. Sourdough starter is a culture of spores living in a mixture of flour and water. The spores break down the starch into sugar and fermentation takes place. Sourdough starter is the basis for all true sourdough recipes, although it has also been used to heal burns and to make a kind of hooch! Some starters are prized possessions and are passed on from generation to generation. As the cultures consume the flour water mixture, the flour and water are replenished. An “overnight starter” can be prepared from two cups of flour, two cups of water and a packet (one tablespoon) of yeast. These ingredients are mixed and stored overnight in a warm place and will double in size in that time. It is generally agreed among sourdough mavens, however, that the best sourdough starters are not made from pre-packaged yeast.

If one desires to have sourdough pancakes on Sunday, and one has sourdough starter, one must get busy on Saturday night. One takes the starter and adds a cup of water, a cup and a half of flour and, optionally, a teaspoon of sugar, mixes well, covers this mixture with a towel and lets it sit overnight at room temperature or a little higher. This is called proofing and it produces a sponge. The next morning, according to conventional recipes, one removes a cup or so of replenished starter/sponge and sets it aside for future use. One uses the remaining mixture to make batter by adding sugar, salt, oil, baking soda, egg and, optionally, milk, and thoroughly mixing the ingredients. The resulting mixture is very active and must be used within a short time such as one half hour. No recipe for sourdough batter is known to the inventor where this mixture is again proofed.

There are, of course, variations on the foregoing recipe. For example, it is known to pre-mix all of the ingredients except baking soda and to mix the baking soda with a small amount of water and add it last to the mixture, just before making pancakes or waffles. In addition, various proportions of ingredients are claimed to be the best. Some recipes include spices and other optional ingredients, such as fruit. There are also a number of shortcuts, but it is generally agreed that every shortcut diminishes the quality of the final product substantially.

### SUMMARY OF THE INVENTION

The invention is based on the discovery that one can produce a sourdough pancake or waffle batter containing all of the ingredients except baking soda, and that such batter can be refrigerated for weeks or frozen for months, with no detrimental effect on the pancakes or waffles produced from the batter. In the case of refrigerated batter, one adds a mixture of baking soda and a little water to the batter, gently mixes the ingredients and prepares pancakes or waffles, preferably within twenty minutes from when the mixture of baking soda and water is added. In the case of frozen batter, one lets it thaw and proceeds as in the case of the refrigerated batter. The invention is based on the further discovery that by proofing sourdough sponge a second time, a remarkably pungent and tasty sourdough batter is created.

Accordingly, it is an object of the invention to provide a virtually complete sourdough pancake or waffle batter that can be refrigerated or frozen and sold as a convenience food.

It is a further object of this invention to provide a virtually complete sourdough pancake or waffle batter that can be mixed with baking soda, preferably pre-mixed with a little water, and used to make sourdough pancakes or waffles within a matter of minutes rather than days.

It is yet another object of this invention to provide a convenience food comprising a sourdough pancake or waffle batter pre-mix which can be mixed with baking soda or baking soda and water and used immediately to make sourdough pancakes or waffles.

It is a further object of the present invention to produce the best tasting, most delicious sourdough pancakes and waffles.

These and other objects and advantages of the invention will be appreciated by one of ordinary skill in the art upon reading the rest of this document.

### DETAILED DESCRIPTION OF THE PREFERRED EMBODIMENTS

SOURDOUGH STARTER. The present invention begins with sourdough starter. The present inventor uses a starter that he has been growing for years. The starter had its humble beginnings as a mixture of flour and distilled water that was left standing, uncovered, for four or five days. Sourdough starter has a special place in the lore of San Francisco, Calif., and many varied starters can be found there. Sourdough starter recipes abound and, for those less enterprising, one can always get some starter from a friend or a friend of a friend By way of example, starter can be made as described above, or as follows:

A. Mix two cups of all-purpose flour with enough lukewarm (distilled) water to form a thick batter. Let this stand uncovered for four or five days, or, until it starts working. Lukewarm milk can be used in place of the lukewarm water.

B. Mix one cup of flour with one cup of room temperature (distilled) water, cover the mixture loosely, for example, with a damp towel, and let stand in a warm place overnight. Next morning, add one cup of flour and about a cup of room temperature (distilled) water. Mix well, cover and let stand in a warm place for up to about twenty-four hours. Repeat the adding of flour and water at least one more time and then let the mixture stand and work in a warm place for a day or so until you see a lot of foam and bubbles on top of the starter, which is then ready for use.

If you ask the inventor what the best starter is, he will tell you that it is his starter. Accordingly, in accordance with the duty to disclose the best mode, readers are invited to contact the inventor for a sample of his starter. Some people might be satisfied to make their own starter using one of the recipes above or other recipes that are widely published.

A preferred method according to the invention for producing a sourdough pancake or waffle batter pre-mix is described below. It will certainly be appreciated that other recipes and/or procedures may be employed, provided that one leaves out the baking soda, and stores the batter pre-mix under refrigeration or freezing, until ready to make pancakes or waffles. At that time, one adds a suitable quantity of baking soda, preferably pre-mixed with a little water, mixes it with the batter pre-mix, and makes pancakes or waffles, preferably within twenty minutes of the final mixing.

SOURDOUGH SPONGE. White flour and distilled or purified water are mixed thoroughly together in a ratio of about one cup of flour to 10 fluid ounces of distilled or purified water, preferably warmed to about 90 degrees F. (32 degrees C.). The flour water mixture is mixed with starter so that the starter comprises about 10 to 20% of this mixture, with the balance being the flour and water mixture. The thickness of this sponge mixture is adjusted, as necessary, by the addition of flour or water, to make the mixture have the consistency of a medium thick batter. This sponge mixture is put into a container and covered loosely, for example, with a damp towel to prevent a crust from forming on the sponge, and the container is put in a warm spot at about 90 degrees F. (32 degrees C.) and held for about eight hours to produce a sponge which will have about twice the volume of the original starter, flour and water mixture. A portion of the sponge is recycled from this mixture, back to a starter container, and reserved for later use as a starter.

The remaining sponge mixture is then re-mixed thoroughly and held for about one or two days, depending on how much “sour” is desired in the final product, at 90 degrees F. (32 degrees C.), again, covered with a damp towel. This step is called proofing. At this stage, according to a preferred embodiment of the present invention, flour amounting to about ten percent by volume of the sponge mixture is added thereto and mixed therewith, and this mixture is held at 90 degrees F. (32 degrees C.), covered with a damp towel, for another day or two, again, depending on how much “sour” is desired. This second proofing step creates a most remarkably tasty and “sour” sourdough sponge. At this stage, the sponge is ready to be mixed with other ingredients to produce sourdough pancake or waffle batter pre-mix.

SOURDOUGH PANCAKE/WAFFLE PRE-MIX. For each gallon of sponge, the following ingredients are added:

Eight eggs,

One half cup of sugar, and

One tablespoon of salt.

This mixture is mixed thoroughly to produce a sourdough pancake or waffle pre-mix, which can be used immediately, as described below, or is immediately refrigerated or frozen. The refrigeration slows down the activity of the batter pre-mix, which can now be held under refrigeration for up to thirty or even forty days, for use in making sourdough pancakes or waffles, as described below. Alternatively, this batter pre-mix can be frozen for up to several months.

SOURDOUGH PANCAKES/WAFFLES. To each cup of batter pre-mix, one adds one-eighth of a teaspoon of baking soda, pre-mixed in a small amount of water such as one or two tablespoons. This produces a pancake batter, which will be very active and should be used within about twenty minutes from the time the baking soda is added. The batter is cooked conventionally, for example, on a griddle heated to about 375 degrees F. (190 degrees C.). A suitable quantity of batter is poured on the griddle and cooked for about two minutes on one side or until bubbles stop forming on the top of the cake. The cake is then flipped and cooked for an additional minute or two and the pancake is ready to serve. The batter can also be used to make waffles. To prevent sticking, one can add a small amount of oil, approximately one half of a teaspoon, per cup of batter. Waffles are made by cooking the batter conventionally on a waffle iron.

It will be appreciated that many kinds of flours and mixtures of flours can be used in making the starter, the sponge and the batter pre-mix of the invention. Excellent results have been obtained with plain old white bread flour. Suitable flours include cake flour, either bleached and/or unbleached, hard and/or soft wheat flour, buckwheat flour, corn flour, rye flour and rice flour, as well as mixtures of these and other flours.

It is preferred that the batter of this invention be made with eggs, as described above. More generally, it is preferred that the batter of the invention contain a water soluble or dispersible protein component. Although it is preferred that this protein component be derived from eggs, it can also be derived from dairy products or egg products such as whole egg yolk, egg white or powdered forms thereof. Other sources of dairy protein that can also be used include caseinates (sodium and potassium), buttermilk, whey and whey protein concentrate and mixtures thereof.

The batter of the invention preferably includes sugar, as described above. More generally, the batter includes a sweetening or sugar component. Cane sugar is preferred, although other sugars and sweeteners may be used, including low molecular weight sugars, sucrose (cane or beet sugar), dextrose (corn sugar), fructose such as corn syrup solids or mixtures thereof. Artificial sweetener can be used in place of some or all of the sugar although it is believed that this substitution will hinder the browning of the pancakes or waffles. Due to the greatly increased equivalent sweetening power of some sugars such as fructose and of artificial sweeteners, minor adjustments may be required in the recipe to maintain a proper liquid/solids balance at a desired sweetening level.

The baking soda constitutes a chemical leavening agent that produces gas bubbles in the batter. Other leavening agents that produce gas bubbles may be used but baking soda is highly preferred.

Water that is used in producing a batter according to the present invention should not contain chlorine such as is found in some municipal water systems and also in some well water. Chlorine can inhibit or even kill the sourdough component of the batter. Distilled water and purified water are preferred waters for use in making batter according to the present invention. Any water that is substantially free of chlorine may be used.

The batter can also include other ingredients that are sometimes included in pancakes including flavorings such as vanillin or maple flavor, coloring agents, fruit such as dried blueberries and the like, in desired amounts.

Preferably, utensils and containers used in making the sourdough batter of this invention will be non-metallic. Some metals can and will react with sourdough starter, sourdough sponge and sourdough batter.

Accordingly, a method for making pancakes or waffles according to the invention comprises the steps of:

1. Mixing flour and water that is substantially chlorine free with a sourdough starter to produce a sponge,

2. Storing the sponge for several hours, preferably loosely covered, at a temperature of about 90 degrees F.,

3. Re-mixing the sponge,

4. Storing the remixed sponge for about one or two days, preferably loosely covered, at a temperature of about 90 degrees F.,

5. Optionally, mixing additional flour with the sponge and storing it for an additional day or two, loosely covered, at a temperature of about 90 degrees F.,

6. Mixing the sponge with eggs or another protein, sugar or another sweetener and salt or a salt substitute to produce a batter pre-mix,

7. Optionally, refrigerating or freezing the batter pre-mix,

8. Adding baking soda or other chemical leavening ingredient, preferably pre-mixed with a little water, to the batter pre-mix to produce a batter, and

9. Making waffles or pancakes from the batter.

It is specifically contemplated that the batter pre-mix will be packaged and distributed for commercial or individual use.

I claim:

1. A method for making pancakes or waffles, said method comprising the steps of
mixing flour and water that is substantially chlorine free with a sourdough starter to produce a sponge,
storing the sponge for several hours, preferably loosely covered, at a temperature of about 90 degrees F.,
re-mixing the sponge,
storing the remixed sponge for about one or two days, preferably loosely covered, at a temperature of about 90 degrees F.,
mixing the sponge with eggs or another protein, sugar or another sweetener and salt or a salt substitute to produce a batter pre-mix,
storing the batter pre-mix by refrigerating or freezing the batter pre-mix,
adding baking soda or other chemical leavening ingredient, preferably pre-mixed with a little water, to the batter pre-mix to produce a batter, and
making waffles or pancakes from the batter.

2. The method claimed in claim 1 which further includes the step of mixing additional flour and water with the stored, re-mixed sponge and re-storing it for an additional day or two, loosely covered, at a temperature of about 90 degrees F.

3. A method for making sourdough pancakes or waffles, said method comprising the steps of
producing a highly active, unleavened pre-mix,
storing and refrigerating the pre-mix,
removing a portion of the pre-mix from storage,
adding an effective amount of baking soda or other chemical leavening ingredient to the removed portion of pre-mix to produce a batter, and
making waffles or pancakes from the batter.

4. A method for making sourdough pancakes or waffle batter, said method comprising the steps of
mixing flour and water that is substantially chlorine free with a sourdough starter to produce a sponge,
storing the sponge for several hours, preferably loosely covered, at a temperature of about 90 degrees F.,
re-mixing the sponge,
storing the remixed sponge for about one or two days, preferably loosely covered, at a temperature of about 90 degrees F.,
mixing additional flour and water with the stored, re-mixed sponge and re-storing it for an additional day or two, loosely covered, at a temperature of about 90 degrees F.
mixing the sponge with eggs or another protein, sugar or another sweetener and salt or a salt substitute to produce a batter pre-mix, and
adding baking soda or other chemical leavening ingredient, preferably pre-mixed with a little water, to the batter pre-mix to produce a batter.

5. The method claimed in claim 4 which includes the additional step of storing the batter pre-mix by refrigerating or freezing the batter pre-mix, before adding the chemical leavening ingredient.

6. The method claimed in claim 4 wherein the chemical leavening ingredient is baking soda.

7. The method claimed in claim 5 wherein the chemical leavening ingredient is baking soda.
